(19) United States
(12) Patent Application Publication
(10) Pub. No.: US 2025/0299132 A1
(43) Pub. Date: Sep. 25, 2025

(54) INTEGRATED SALES LEADS MATCHING PLATFORM

(71) Applicant: Lee Brown, Jensen Beach, FL (US)

(72) Inventor: Lee Brown, Jensen Beach, FL (US)

(21) Appl. No.: 18/613,182

(22) Filed: Mar. 22, 2024

(51) Int. Cl. G06Q 10/0631; G06Q 10/0639

(52) U.S. Cl. CPC G06Q 10/06316; G06Q 10/06393

(57) ABSTRACT

A computer-based method for managing sales leads matching systems is provided. The method includes the steps of entering potential lead data. The method also includes the steps of inputting available sales resources. The method further includes the steps of loading selected past saved sales schedules. The method additionally includes the steps of updating industry specific data. The method includes the steps of integrating updated sales leads matching algorithm output. The method also includes the steps of creating new sales schedules based on the integrated updated sales leads matching algorithm output. The method further includes the steps of issuing new sales schedules to the available sales resources, recording data from execution of the sales schedules for the available sales resources, calculating a new sales leads matching algorithm output, and utilizing the new sales leads matching algorithm output to develop a next generation of new sales schedules.

### FIELD OF THE INVENTION

The present invention relates generally to sales leads systems, and more particularly, to sales leads matching systems, which utilize algorithms to design and select appropriate constituent components for matching sales leads to sales resources and to provide an overall administrative platform system to manage an integrated sales leads matching system.

### Computer Program Listing Appendix

The present invention incorporates all Appendices in its entireties.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Many methods, devices, and systems have been unsuccessfully attempted to integrate a comprehensive platform for managing sales leads and matching those leads with sales resources in an effective and efficient manner taking into consideration input resources and functional application. Many of these previous attempts were costly and cumbersome to use and quite often did not take into consideration all of the rapidly changing variables.

Quite often sales professionals employ manually selected processes to choose sales leads and match them with sales resources. These manual processes are time consuming, are vulnerable to subjective personnel choices, and ultimately more expensive due to the variability of factors that are involved in selecting the optimum sales resource and matching them with the appropriate sales lead.

Accordingly, there is an established need for sales leads matching systems which solve at least one of the aforementioned problems. Further, there is an established need for sales leads matching systems which can be utilized more efficiently and effectively and provide a variety of desired sales resource matching options, while meeting functional demands, without excessive costs and excessive manual transaction costs.

### SUMMARY OF THE INVENTION

The present invention is directed to innovative and cost-effective sales leads matching systems which can be utilized to efficiently and effectively match sales leads with appropriate sales resources. Further, the present invention is directed to innovative, streamline designed, sales leads matching tools utilizing unique algorithms to provide sales professionals the ability to match sales leads with the optimum sales resources.

In an aspect, a computer-based method for managing sales leads matching systems is provided. The method includes the steps of entering potential lead data. The method also includes the steps of inputting available sales resources. The method further includes the steps of loading selected past saved sales schedules. The method additionally includes the steps of updating industry specific data. The method includes the steps of integrating updated sales leads matching algorithm output. The method also includes the steps of creating new sales schedules based on the integrated updated sales leads matching algorithm output. The method further includes the steps of issuing new sales schedules to the available sales resources, recording data from execution of the sales schedules for the available sales resources, calculating a new sales leads matching algorithm output, and utilizing the new sales leads matching algorithm output to develop a next generation of new sales schedules.

In embodiments, the method includes carrying out the steps with a mobile application.

In embodiments, the method includes industry specialized discounts which are included in algorithms utilized in application of the computer-based method for managing sales leads matching systems.

In embodiments, the method includes sales matching algorithms.

In embodiments, the algorithms include a plurality of unique steps and interactions, and the method includes unique steps within the sales matching algorithm which include aggregating sales information from profile data. The method also includes the steps of assessing sales representative data. The method further includes the steps of applying weighting factors based on industry specific data. The method additionally includes the steps of modifying the weighting factors based on past sales demographics data. The method includes the steps of interacting with artificial intelligence to modify the weighting factors. The method also includes the steps of personalizing sales representative data based on individual human resources, their roles, historical performance, and personal history. The method further includes the steps of developing trends for individual human resources. The method additionally includes the steps of providing an iterative process wherein the sales matching algorithm continues to refine the weighting factors for the individual human resources.

In embodiments, the method includes steps for generating management key indicators wherein the key indicators are differentiated for use at a business owner level, manager level, sales force director level, and call center level, wherein the method comprises the steps of inputting selected past key indicators; the steps of applying individual human resource execution data; the steps of incorporating forecasting information; updating fiscal data; and the steps of generating dashboard data for use at the business owner, manager level, sales force director level, and call center level.

In another aspect, A computer program system, comprising a computer usable medium having a computer readable program code therein, the computer readable program code adapted to be executed for managing sales leads matching systems is provided. The method includes the steps of entering potential lead data; inputting available sales resources; the method includes the steps of loading selected past saved sales schedules; updating industry specific data. The method includes the steps of integrating updated sales leads matching algorithm output. The method also includes the steps of creating new sales schedules based on the integrated updated sales leads matching algorithm output. The method further includes the steps of issuing new sales schedules to the available sales resources. The method additionally includes the steps of recording data from execution of the sales schedules for the available sales resources. The method includes the steps of calculating a new sales leads matching algorithm output. The method also includes utilizing the new sales leads matching algorithm output to develop a next generation of new sales schedules.

In yet another aspect, a computer program system, comprising a computer usable medium having a computer readable program code therein, the computer readable program code adapted to be executed for managing service providers and task matching systems is provided. The method includes the steps of entering potential task lead data. The method also includes the steps of inputting available service providers. The method further includes the steps of loading selected past saved service provider and task schedules. The method additionally includes the steps of updating industry specific data. The method includes the steps of integrating updated service providers and task matching algorithm output. The method also includes the steps of creating new service provider and task schedules based on the integrated updated service providers and task matching algorithm output. The method further includes the steps of issuing new service providers and task matching schedules to the available sales resources. The method additionally includes the steps of recording data from execution of the service providers and task matching schedules for the available sales resources. The method includes calculating a new service providers and task matching algorithm output. The method also includes the steps of utilizing the new service providers and task matching algorithm output to develop a next generation of new service providers and task matching schedules.

In embodiments, the system can include unique computer programs which can be used in real time by designers to choose a surface design pattern utilizing a plurality of shapes and/or patterns such as but not limited to snowflakes, triangles, circles, squares, trapezoids, ellipses, globules, free form enclosed two dimensional rounded shapes, silhouette shapes of persons, animals, common objects, and/or a combination.

In embodiments, the system can include unique computer programs which can be used in real time by sales managers to match sales leads with sales representatives with a self learning continuing improving set of algorithms such that the platform continues to improve itself with historical performance data generating within the platform.

In embodiments, the system can include rules and/or discounts and/or personal information to take into account when matching sales leads to sales resources.

In embodiments, the system can include a plurality of mobile devices and internet-based algorithms.

In embodiments, the system can include algorithms designed to continuously redefine the rules and protocols being utilized based on previously recorded job evolutions.

In embodiments, the system can include self learning algorithms.

In embodiments, the system can allow previously manual transaction limited managerial evolutions to take place under the supervision of one person with the goal of optimizing sales leads matching.

In embodiments, the system can function to match functional tasks with available resources in order to efficiently and effectively carry out identified tasks.

These and other features and advantages will become apparent from the following detailed description of illustrative embodiments thereof, which is to be read in connection with the accompanying drawings.

### BRIEF DESCRIPTION OF THE DRAWINGS

The features and advantages of the present invention will be better understood when the Detailed Description of the Preferred Embodiments given below is considered in conjunction with the figures provided.

FIG. 1 is a functional schematic view of components and communications pathways in an embodiment of the present invention;

FIG. 2 is a flow chart listing steps included in a method of matching sales leads in an embodiment of the present invention;

FIG. 3 is a flow chart listing steps included in a method of matching sales leads in an embodiment of the present invention; and

FIG. 4 is a flow chart listing steps included in a method of matching sales leads in an embodiment of the present invention;

### DETAILED DESCRIPTION

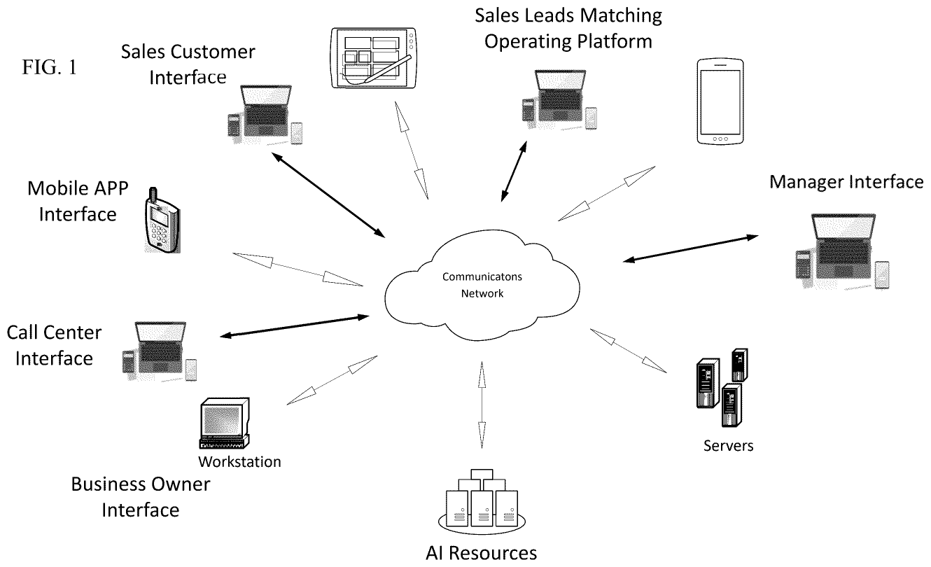

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Referring initially to FIG. 1, an overview of system components and communications pathways are illustrated. In embodiments, computer software, algorithms and specialized rules are applied, mobile devices, Wi-Fi and other wireless and wired communications are used to connect devices, in order to utilize embodiments of sales leads matching system. A sales customer, a manager, a business owner, call center interfaces, and manager interfaces can utilize a mobile device to interact with the system to conduct sales leads matching and operating the platform. Utilizing laptops, desktops, and/or other mobile devices a business representative can interact with all requisite business components in order to conduct sales leads matching which can be performed in an almost real time fashion.

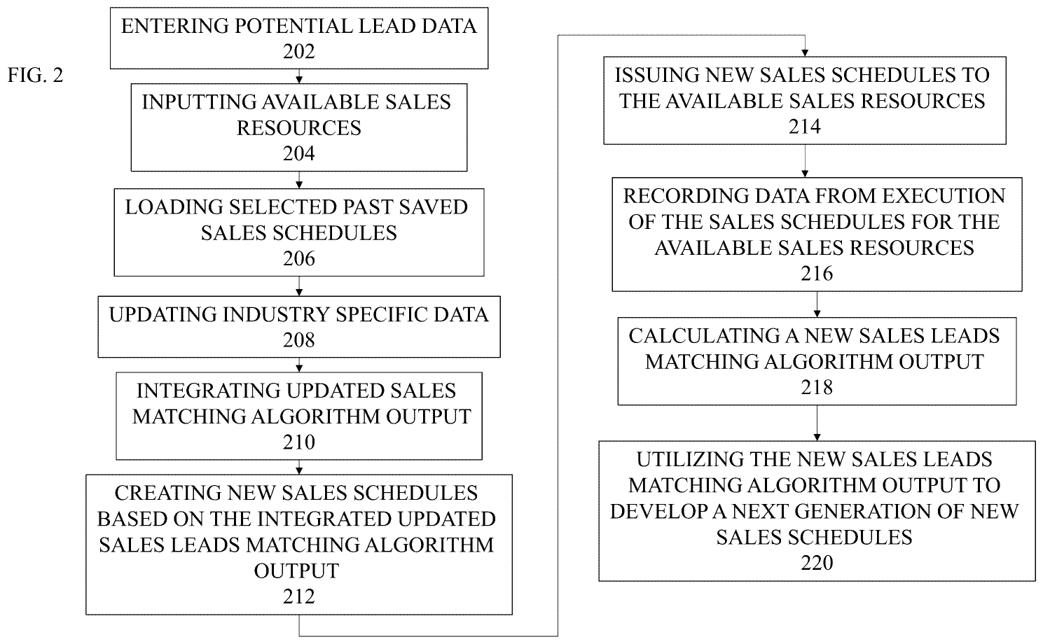

FIG. 2 shows steps in a method of an embodiment of the present invention. The program can allow for loading saved rules, discounts and protocols that are used in sales matching evolutions. The method can include the steps of entering potential lead data 202 that are updated based time sensitive material availability and pricing information. Also, the method can include the steps of inputting available sales resources 204. The program can include steps of loading selected past saved sales schedules 206. The program can include the steps of updating industry specific data 208. The system can include the steps of integrating updated sales matching algorithm output 210. Further, the program can allow for including the steps of creating new sales schedules based on the integrated updated sales leads matching algorithm output 212. Also, the program can allow for choosing new sales schedule and include the steps of issuing new sales schedules to the available sales resources 214. Additionally, the program can allow for creating a historical database for building and self-learning evolutions by including the steps of recording data from execution of the sales schedules for the available sales resources 216. The system continuously self learns and applies new decision making weighted factors by including the steps of calculating a new sales leads matching algorithm output 218. The system provides unique updated continuously improved matching algorithms by including the steps of utilizing the new sales leads matching algorithm output to develop a next generation of new sales schedules 220.

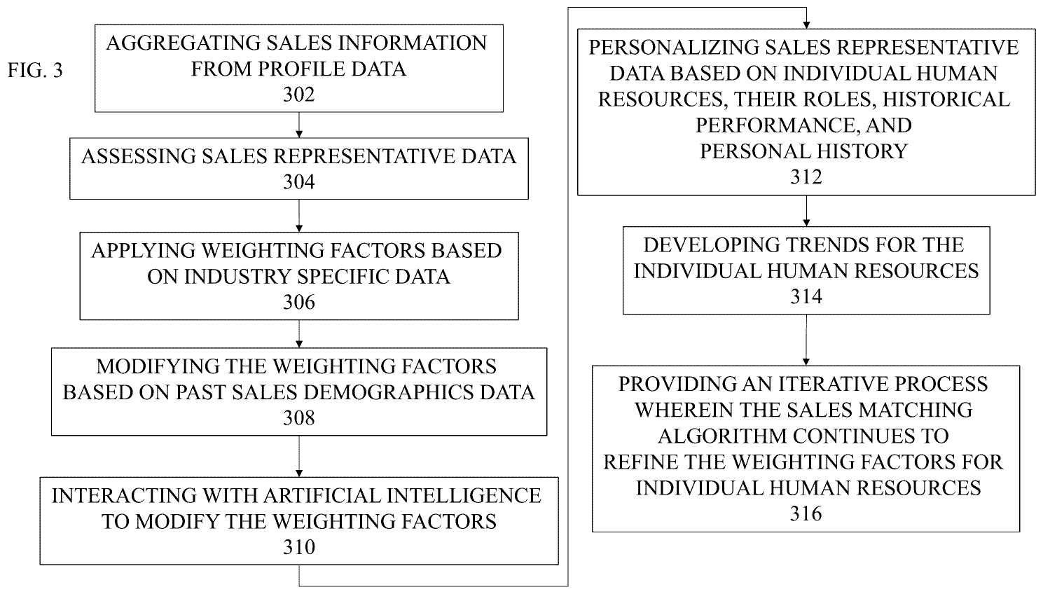

Turning to FIG. 3, the program can include considerations for importing self learning, continuously improving factors, weighted factors, discounts, personalized information, real time data with respect to geographical areas, availability of personnel, The method can include the steps of aggregating sales information from profile data 302. The method can include real time assessment data to canvas available data in order to differentiate, rank, and optimally match sales leads with sales resources by assessing sales representative data 304. The system can further refine the matching process by applying weighting factors based on industry specific data 306. The system can also provide efficiency and effectiveness by including the steps of modifying the weighting factors based on past sales demographics data 308. In embodiments of the present invention, the system can continuously improve by incorporating system input from custom queries from artificial intelligence (AI) routines by interacting with AI to modify the weighting factors 310.

Continuing in FIG. 3, system users can utilize a plurality of historical databases to fine tune, weight, factor, and differentiate sales resources. The system platform allows for personalizing sales representative data based on individual human resources, their roles, historical performance, and personal history 312. The self learning algorithms can then develop continuously refining routines to apply to the data in order to obtain the optimum differentiation amongst available human resources. The system and/or platform can allow the steps of developing trends of the individual human resources 314. Ultimately, the platform and system continues to improve with the overall ability to efficiently and effectively match sales leads to available resources with the goal of maximizing sales, minimizing costs, and enhanced operational control of the business platforms through the use of the system. The system can also present for the steps of providing an iterative process wherein the sales matching algorithm continues to refine the weighting factors for individual human resources 316.

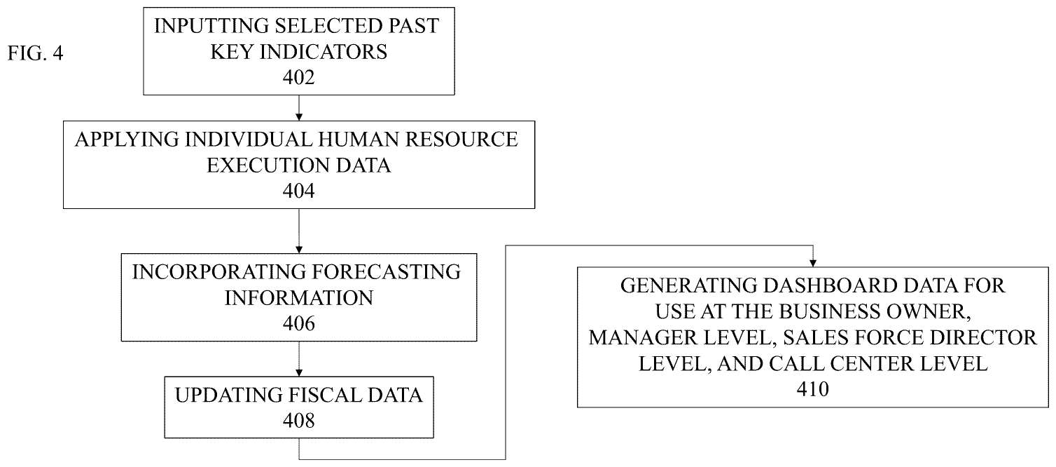

As best seen in FIG. 4, the system can include methods allowing for managerial functions to take place when using the system. In embodiments, the system can allow business operational managers to have the operational managerial tools in the way of key data indicators in order to make management decisions. For example, the system can provide the steps of inputting selected past key indicators 402 as a starting point and/or a refining ongoing process wherein the platform can supply management data. The system can include the steps of applying individual human resource execution data 404. The system can further provide the steps of incorporating forecasting information 406. The platform can include the steps of updating fiscal data 408. The system can also provide the steps of generating dashboard data for use at the business owner, manager level, sales force director level, and call center level 410.

In embodiments, the system and platform provides fixes to a lot of the challenges with issuing leads on any a scale. Once you grow and you're issuing 20, 30, 40, 50 leads, managing sales matching evolutions becomes a big challenge for a human to lay that out. Embodiments of this present invention provide integrated data aggregation and data differentiation and weighting, which continues to self-improve with the algorithms, in order to provide sales leads matching that has never been before.

In embodiments, the system has provided and has developed into an aggregator of information. It will take all this information that the call center gets from a homeowner, which may be in the form of a discount or it can be in any form of a script.

In embodiments, the system can organically refined weighting factors with internal, external, and modified with AI routines to build the factors and considerations used in the platform. In embodiments we built a profile both from public information and asking the consumer. We build them from profiles of their likes and dislikes. What magazines you subscribe to is public information, your home values is public information. Your political records is even public information. Then anything we can't get publicly, which the system will automatically go and data mine from public records, we will ask you in a bit more than a year of a discount.

In embodiments, the system can provide platforms to any industry and any business wherein matching needs to available resources in an efficient and effective manner may be useful. This information can be really any question that's important to the company. And this is also a key distinguishing capability. To customize the platform for specific industries and specific end users so that the data and matching is pertinent and useful.

In embodiments, the system can customize platforms to any industry and provide specific data to businesses that are important to that business and industry. So what's important to windows may not be important to floor coatings, but may be important to foundation repair. So they're interchangeable. And what that system does is it will start to assign a score to it, a probability ranking or scoring.

In embodiments, the system provides an integrated management platform to manage personalized information, sales leads, and available resources. The system can be an enhanced, integrated, multi-sourced, customizable, highly proficient lead matching software. This is the legacy portal here. We're revamping everything to make it quicker and add some stuff to it, especially with AI component integration.

In embodiments, the system can have global application. For instance, if you're able to do refined matching with the sales entities, correct, as far as their capabilities, propensities, percentage of success rate, so forth, you can apply this to any industry, any business, goods, products, retail, wholesale, real estate, real estate your service sales products, it doesn't matter. As long as you're able to define the specifics of what's going to be successful and what the sales rep or the human interface is going to have to offer, this can be applied to anything.

In embodiments, the system provides management data for business owners and managers with dashboards. A dashboard is really for your managers. It's for giving you just a high level oversight. It becomes quite a burden to manage all these people, all these offices. This helps you monitor all your data. A closing leaderboard, this will typically have a list, sales reps.

In embodiments, the system can factor, differentiate, discount, and/or weigh data. You can modify the weight of importance for them. For example, if you have a common question like property value and the age or political affiliations, there's typically data subscriptions available to help pull that data in automatically. If there's a question that you don't have easily available, like military service, for example, that is a question your call center is going to have to ask.

In embodiments, the system provides an integrated platform to carry out iterative functions which were not possible before. The system can takes data from your sales reps, takes characteristics from sales reps, it takes characteristics from both private and public information from a homeowner or a prospect, and it tries to match them. Based on an interchangeable series of questions that are weighted based on the higher percentage a prospect receives to a sales rep is typically who that prospect is going to go to. We believe that a lot of the sale is based on rapport and if we can match a sales rep with a prospect with a lot of common links, we have a much higher probability of making that sale perfect.

In embodiments, the platform designed for any sort of sales, any sort of entity wanting to improve their sales or to manage their sales program and enhance it within the platform. You've got portals that exist not only for the administrator of the platform, for that person that's using it for their company, but also you have portals for individual salespeople.

In embodiments, the modifications and customizations that we're looking at here are geared for some of the business or some of the industries that right now you and your legal entities engaged with. This platform could be useful for any business in any industry as long as there's that sales matching need with respect to leads and salespeople and the demographics and just different feed points. So when you're customizing this thing and you're correct, there's so many different variables you could consider. But if you consider 2,000, you would spend, it just wouldn't be cost effective to do anything, and you may have diminishing returns on some of these variables you're choosing.

In embodiments, the system can take different pieces of data, what's relevant to you, close percentage, demo percentage, the source percentages to help get a picture of how your business is performing. So if I am, we have a bunch of sources, NASCAR, NFL, just general television. You have Internet sources, you have hundreds and hundreds, if not thousands of sources that your data is coming from. You want to see how those are performing as well. So you can run a report that will take that data, take your closed data, your demo data, your average sale data, and it'll show you what sources are performing the best. So if direct mail is crushing it and maybe we're not getting good results with Canvas, we're not getting good demo percentages, we're going to pull back some of the resources from canvassing, put them in direct mail. It only makes sense. You have a source that's performing better. It's returning more money per money spent. You're getting more ROI essentially on your marketing dollars.

In embodiments, the system can be a tool for the sales and marketing side. So we want to take your existing data and make it as high performing as it possibly can be. We also want to give you guidance on improving that data and guidance on increasing your sales. So how much getting guidance and saying, okay, you know what? I'm spending $300.000 a month this month on marketing. It's going to return about a million five for me. But I have 28 sales reps and a million five is not going to work with 28 sales reps. I need to go do 2.5 million in business. What do I need to do to do that? How much do I need to spend? Where do I need to spend it? Where is going to give me the highest return on those dollars?

In embodiments, the system can be this data aggregation platform, matching sales leads. We're using those different resources that have been used before. Iterative process. We're touching AI. We're generating a platform for reporting structures, for super vision, for business owners, for different things, trying to make it user, trying to make it specific for different industries helps manage your block with the amount of data you have coming in. So the data, the matching between sales reps and customers, it doesn't even have to be focused against sales reps. It could be, for example, installers. So you could tweak the system and have it matched. You could have an installer match to a particular job based on skill set. So for example, if I have a school deck that I'm installing, or a garage or a patio, we could take that system and match it with installers based on skill level, efficiency, percentages, weather, all that. So you can swap in and swap out those data points for really whatever your end goal is.

In embodiments, the platform can use the internally generated and improved algorithms, which are designed to be self-learning, the system is able to do is aggregate this data specifically at each touch point, at the sales point, at the call center, at the managing center, at the business owner center, and based on their experience in the past, historical data, you can give weight factors, you can develop weight factors for each one of these things to give it priority in matching these sales leads, like the logistics for driving distances, for instance, or logistics with actual percentage of success rates and different types of scenarios for different salespeople. So you have this unique thing that you can get this data, you can specialize different weighting factors, different things for these different people, and you're using the human interface with the people and being able to go ahead and give it some sort of factor, some sort of weight. And aggregating all these weight factors gives you a more streamlined process of being able to go ahead and match the leads to whatever it is you're trying to sell.

In some embodiments, the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

What is claimed is:

1. A computer-based method for managing sales leads matching systems, the method comprising the steps of:
entering potential lead data;
inputting available sales resources;
loading selected past saved sales schedules;
updating industry specific data;
integrating updated sales leads matching algorithm output;
creating new sales schedules based on the integrated updated sales leads matching algorithm output;
issuing new sales schedules to the available sales resources;
recording data from execution of the sales schedules for the available sales resources;
calculating a new sales leads matching algorithm output;
wherein the new sales leads matching algorithm includes
a self-learning continuing improving set of algorithms;
wherein the self-learning continuing improving set of algorithms include continuously monitoring and refining weight factors being utilized and continuously replacing the weight factors with new weight factors based at least on industry specific data and a user input;
updating the self-learning continuing improving set of algorithms based on the new weight factors in real time using artificial intelligence (AI); and
wherein the self-learning continuing improving set of algorithms continues to improve itself with corrections based on system output in real time; and
utilizing the new sales leads matching algorithm output to develop a next generation of new sales schedules;
determining location-based preferences for multiple locations;
inputting the sales resources locations;
calculating drive times of the sales resources based on the sales resources locations and the next generation of new sales schedules; and
giving the sales resources a refined sales appointment based on adjustments to the next generation of new sales schedules from the determining location-based preferences for multiple locations, the inputting the sales resources locations, and the calculating drive times of the sales resources based on the sales resources locations and the next generation of new schedules.

2. The method as recited in claim 1, wherein the method is carried out with a mobile application.

3. The method as recited in claim 1, wherein industry specialized discounts are included in algorithms utilized in application of the computer-based method for managing sales leads matching systems.

4. The method as recited in claim 1, wherein steps within the sales matching algorithm include:
aggregating sales information from profile data;
assessing sales representative data;
applying the weight factors based on the industry specific data;
modifying the weighting factors based on past sales demographics data;
interacting with artificial intelligence to modify the weighting factors;
personalizing sales representative data based on individual human resources, their roles, historical performance, and personal history;
developing trends for the individual human resources; and
providing an iterative process wherein the sales matching algorithm continues to refine the weighting factors for the individual human resources.

5. The method as recited in claim 1, wherein the method includes steps for generating management key indicators wherein the key
indicators are differentiated for use at a business owner level, manager level, sales force director level, and call center level, wherein the method comprises:
inputting selected past key indicators;
applying individual human resource execution data;
incorporating forecasting information;
updating fiscal data; and
generating dashboard data for use at the business owner, manager level, sales force director level, and call center level.

6. A computer program system, comprising a non-transitory computer usable medium having a computer readable program code therein, the computer readable program code adapted to be executed for managing sales leads matching systems, the method comprising:
entering potential lead data;
inputting available sales resources;
loading selected past saved sales schedules;
updating industry specific data;
integrating updated sales leads matching algorithm output;
creating new sales schedules based on the integrated updated sales leads matching algorithm output;
issuing new sales schedules to the available sales resources;
recording data from execution of the sales schedules for the available sales resources;
calculating a new sales leads matching algorithm output;
wherein the new sales leads matching algorithm includes
a self-learning continuing improving set of algorithms;
wherein the self-learning continuing improving set of algorithms include
continuously monitoring and refining weight factors being utilized and continuously replacing the weight factors with new weight factors based at least on industry specific data and a user input;
updating the self-learning continuing improving set of algorithms based on the new weight factors in real time using artificial intelligence (AI);
wherein the self-learning continuing improving set of algorithms continues to improve itself with corrections based on system output in real time;
and
utilizing the new sales leads matching algorithm output to develop a next generation of new sales schedules;
determining location-based preferences for multiple locations;
inputting the sales resources locations;
calculating drive times of the sales resources based on the sales resources locations and the next generation of new sales schedules; and
giving the sales resources a refined sales appointment based on adjustments to the next generation of new sales schedules from the determining location-based preferences for multiple locations, the inputting the sales resources locations, and the calculating drive times of the sales resources based on the sales resources locations and the next generation of new schedules.

7. A computer program system, comprising a non-transitory computer usable medium having a computer readable program code therein, the computer readable program code adapted to be executed for managing service providers and task matching systems, the method comprising:
entering potential task lead data;
inputting available service providers;
loading selected past saved service provider and task schedules;
updating industry specific data;
integrating updated service providers and task matching algorithm output;
creating new service provider and task schedules based on the integrated updated service providers and task matching algorithm output;
issuing new service providers and task matching schedules to the available sales resources;
recording data from execution of the service providers and task matching schedules for the available sales resources;
calculating a new service providers and task matching algorithm output; wherein the new service providers and task matching algorithm includes
a self-learning continuing improving set of algorithms;
wherein the self-learning continuing improving set of algorithms include
continuously monitoring and refining weight factors being utilized and continuously replacing the weight factors with new weight factors based at least on industry specific data and a user input; and
updating the self-learning continuing improving set of algorithms based on the new weight factors in real time using artificial intelligence (AI);
wherein the self-learning continuing improving set of algorithms continues to improve itself with corrections based on system output in real time;
and
utilizing the new service providers and task matching algorithm output to develop a next generation of new service providers and task matching schedules;
determining location-based preferences for multiple locations;
inputting the service providers locations;
calculating drive times of the services providers based on the service providers locations and the next generation of new task matching schedules; and
giving the service providers a refined service appointment based on adjustments to the next generation of new service providers and task matching schedules from the determining location-based preferences for multiple locations, the inputting the service provider locations, and the calculating drive times of the service providers based on the service providers locations and the next generation of new service providers and task matching schedules.
